(19) United States
(12) Patent Application Publication
(10) Pub. No.: US 2014/0097788 A1
(43) Pub. Date: Apr. 10, 2014

(54) METHOD AND SYSTEM FOR CHARGING BATTERY

(71) Applicant: SAMSUNG SDI CO., LTD., Yongin-si (KR)

(72) Inventors: Bong-Young Kim, Yongin-si (KR); In-Kyu Park, Yongin-si (KR)

(73) Assignee: SAMSUNG SDI CO., LTD., Yongin-si (KR)

(21) Appl. No.: 13/786,864

(22) Filed: Mar. 6, 2013

(30) Foreign Application Priority Data
Oct. 4, 2012 (KR) 10-2012-0110089

(51) Int. Cl. H02J 7/00

(52) U.S. Cl. CPC H02J 7/007
USPC 320/107; 320/137; 320/150; 320/162

(57) ABSTRACT

A method of charging a battery including at least one battery cell includes supplying a first current for charging the battery a first charge period, and supplying a second current for charging the battery for a second charge period, where the second current is less than the first current. The method also includes supplying a constant voltage for charging the battery for a set charge period.

### CROSS-REFERENCE TO RELATED APPLICATIONS

This application claims the benefit of Korean Patent Application No. 10-2012-0110089, filed on Oct. 4, 2012, in the Korean Intellectual Property Office, the disclosure of which is incorporated herein in its entirety by reference.

### BACKGROUND

1. Field

One or more embodiments of the present invention relate to a battery charge system and method capable of reducing a charge time of the battery.

2. Description of the Related Technology

Research is being actively conducted on secondary batteries in conjunction with the development of portable electronic devices, such as cellular phones, notebook computers, camcorders, and personal digital assistants (PDAs).

A secondary battery is generally manufactured in the form of a battery pack including a battery and a charge/discharge circuit, and the battery is recharged or discharged via an external terminal of the battery pack by using external power or an external load. When the battery pack is connected via the external terminal to the external power, the external power is charged into the battery via the external terminal and the charge/discharge circuit. Also, when the battery pack is connected to the external load via the external terminal, power of the battery is discharged via the charge/discharge circuit and the external terminal to the external load. The charge/discharge circuit controls charge/discharge operations of the battery between the external terminal and the battery.

In general, a battery is charged by charging the battery at a maximum charge current until a voltage of the battery reaches a certain voltage, and gradually reducing the charge current after the voltage of the battery reaches the certain voltage.

### SUMMARY OF CERTAIN INVENTIVE ASPECTS

One or more embodiments of the present invention include a battery charge system and method capable of reducing a charge time of the battery.

Additional aspects will be set forth in part in the description which follows and, in part, will be apparent from the description, or may be learned by practice of the presented embodiments.

According to one or more embodiments of the present invention, a method of charging a battery includes supplying a first current for charging the battery for a first charge period, and supplying a second current for charging the battery for a second charge period, where the second current is less than the first current; and supplying a voltage for charging the battery for a set charge period.

The method may further include determining whether the battery has a remaining capacity if the battery is maintained at a current less than the first or the second current; and charging the battery at the first or second current regardless of the set charge period.

The method may further include stopping a charge operation of the battery if a temperature of the battery is greater than a predetermined temperature; and restarting the charge operation of the battery if the temperature of the battery drops to a temperature less than the predetermined temperature.

The method may further include supplying a third current for charging the battery for a third charge period, where the third current is less than the second current.

If the battery is maintained at a current less than the first current for a predetermined period, it may be determined that the battery has a first remaining capacity, and the battery is charged up to the second current regardless of the first charge period.

If the battery is maintained at a current less than the second current for a predetermined period, it may be determined that the battery has a second remaining capacity, and the battery is charged up to the third current regardless of the second charge period.

According to one or more embodiments of the present invention, a system for charging a battery includes the battery including at least one battery cell; a constant current charge unit for supplying a first current for charging the battery for a first charge period, and supplying a second current for charging the battery for a second charge period, where the second current is less than the first current,; a constant voltage charge unit for supplying a set voltage for charging the battery for a set charge period; and a charge control unit for monitoring a state of the battery and controlling operations of the constant current charge unit and the constant voltage charge unit.

The charge control unit may determine whether the battery has a remaining capacity if the battery is maintained at a current less than the first or second current for a predetermined period, and may charge the battery at the first or second current regardless of the set charge period.

The system may further include a temperature measuring unit for measuring a temperature of the battery.

The charge control unit may stop operation of the constant current charge unit if the temperature of the battery is greater than a predetermined temperature, and may restart the operation of the constant current charge unit if the temperature of the battery drops to a temperature less than the predetermined temperature.

The constant current charge unit may supply a first current for a first charge period; a second current less than the first current for a second charge period; and a third current less than the second current for a third charge period.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram of a battery charge apparatus according to an embodiment of the present invention;

FIG. 2 is a detailed block diagram of a control unit for charging a battery illustrated in FIG. 1;

FIG. 3 is a graph showing a charge curve of a battery illustrated in FIG. 1;

FIG. 4 is a flowchart of a battery charge method according to an embodiment of the present invention;

FIG. 5 is a flowchart of a battery charge stop/restart operation in the method illustrated in FIG. 4; and

FIG. 6 is a detailed flowchart of the method illustrated in FIG. 4.

### DETAILED DESCRIPTION OF CERTAIN INVENTIVE EMBODIMENTS

Reference will now be made in detail to embodiments, examples of which are illustrated in the accompanying drawings, wherein like reference numerals generally refer to like elements throughout. In this regard, the present embodiments may have different forms and should not be construed as being limited to the descriptions set forth herein. Accordingly, the embodiments are merely described below, by referring to the figures, to explain aspects of the present description.

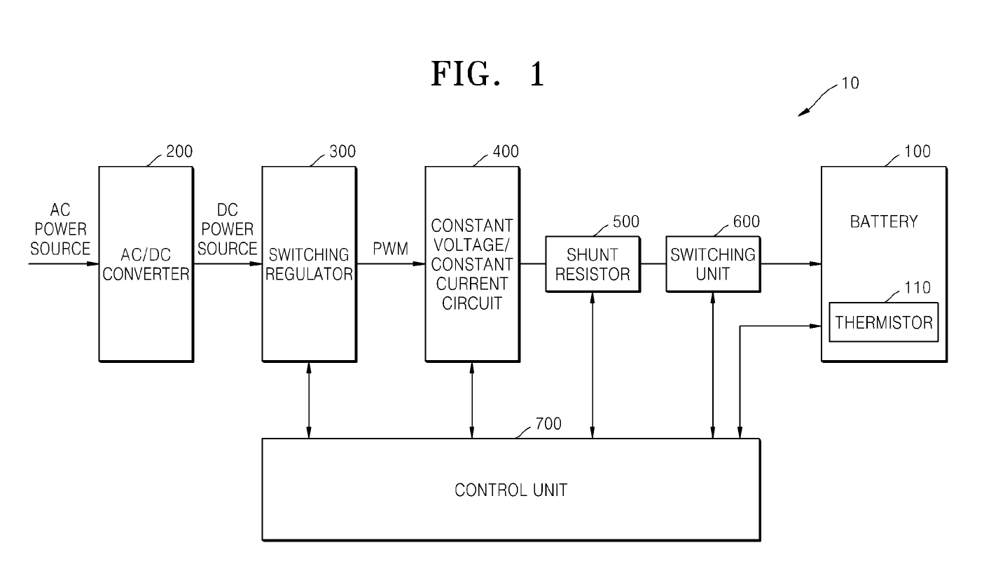

FIG. 1 is a block diagram of a battery charge system 10 according to an embodiment of the present invention.

Referring to FIG. 1, the battery charge system 10 may include a battery 100, an alternating current (AC)/direct current (DC) converter 200, a switching regulator 300, a constant voltage/constant current circuit 400, a shunt resistor 500, a switching unit 600, and a control unit 700.

The battery 100 may be loaded in, and supply power to, an electronic device, and may be recharged by using external power. The battery 100 may include at least one battery cell (not shown). The battery cell may be a rechargeable secondary battery, such as a nickel-cadmium battery, a lead acid battery, a nickel metal hydride (NiMH) battery, a lithium ion battery, a lithium polymer battery, or the like.

An AC power source applies an AC voltage to the battery charge system 10. The AC power source can include a typical power source for generating an AC voltage of which a size and direction cyclically change as time passes. In some embodiments, an AC voltage of 220V and 60 Hz can be supplied and used as a standard voltage. In other embodiments, the AC power source is not limited to such a distribution voltage.

The AC/DC converter 200 converts the AC voltage into a DC voltage after filtering out noise of the AC voltage, such as for example, noise from electromagnetic interference (EMI). For this purpose, the AC/DC converter 200 includes an AC EMI filter (not shown). EMI refers to a phenomenon that electromagnetic waves subordinately generated by an electronic device influence the operation of the electronic device or another electronic device. Accordingly, an EMI filter is used to reduce EMI, and examples of the EMI filter include an X-capacitor, a Y-capacitor, a line filter, and the like.

The switching regulator 300 regulates the DC voltage input from the AC/DC converter 200 to a desired DC voltage. The switching regulator 300 changes a ratio between an on time and an off time of a switching transistor by maintaining a pulse signal of a certain frequency and changing a duty cycle of the pulse signal. The switching regulator 300 also adjusts an output voltage to be constant by using pulse width modulation (PWM) for controlling an average value of a smoothed output voltage to be constant. The control unit 700 may adjust an output voltage by outputting a signal for changing the duty cycle of the switching regulator 300.

The constant voltage/constant current circuit 400 rectifies by using a rectification circuit a PWM voltage signal output from the switching regulator 300, and outputs a certain constant voltage signal and a constant current signal.

The shunt resistor 500 detects a voltage and a current output from the constant voltage/constant current circuit 400, and outputs the voltage and the current to the control unit 700. The control unit 700 compares the detected voltage and the current to a reference voltage and a reference current, respectively, and turns off the switching unit 600 to stop a charge operation if the detected voltage and the current are determined as an overcurrent and an overvoltage, respectively.

The switching unit 600 switches a constant voltage and a constant current output from the constant voltage/constant current circuit 400 to the battery 100, and is opened to stop the charge operation when an overvoltage or an overcurrent is generated. When the charge operation is completed, the switching unit 600 may also be opened to stop the charge operation and to protect the battery 100

The control unit 700 controls a constant current charge step and a constant voltage charge step of the battery 100 by controlling operations of the switching regulator 300, the constant voltage/constant current circuit 400, the shunt resistor 500, and the switching unit 600. The control unit 700 may control an output voltage by outputting a signal for changing the duty cycle of the switching regulator 300, and may control an output voltage/current of the constant voltage/constant current circuit 400 by using a voltage/current detected by the shunt resistor 500. Also, the control unit 700 may control operation of the switching unit 600 by using a voltage/current detected by the shunt resistor 500. Furthermore, the control unit 700 may control to stop and restart the charge operation of the battery 100 by sensing a temperature of the battery 100 by using an output signal of a thermistor 110 included in the battery 100. In some embodiments, the thermistor 110 may be formed outside the battery 100.

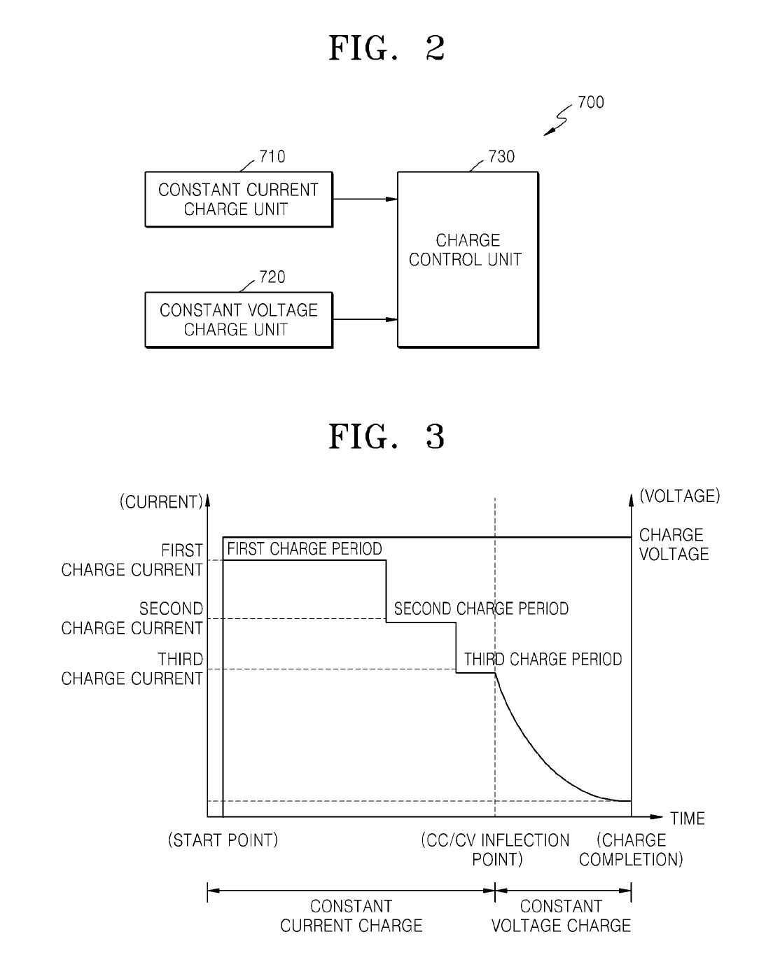

FIG. 2 is a detailed block diagram of the control unit 700 for charging the battery 100 illustrated in FIG. 1. Referring to FIG. 2, the control unit 700 may include a constant current charge unit 710, a constant voltage charge unit 720, and a charge control unit 730 for controlling a constant current charge step and a constant voltage charge step.

The battery 100 is generally charged in a constant current/constant voltage (CC-CV) mode. A charge current is maintained constant when charging is started, and a charge voltage is maintained constant when a charge level is increased to a certain level.

In some embodiments, a charge time of the battery 100 may be reduced by reducing a charge current of a constant current charge period of the battery 100 in steps.

The constant current charge unit 710 reduces at least one charge current in steps in the constant current charge period, and charges the battery 100 for a charge period set to each step. For example, the constant current charge unit 710 may charge the battery 100 by setting the charge current and the constant current charge period as a first charge current having the highest current value (for example, 7 A) and a first charge period (for example, 10 min.), a second charge current that is less than the first charge current (for example, 6 A) and a second charge period that is less than the first charge period (for example, 4 min.), and a third charge current that is less than the second charge current (for example, 5 A) and a third charge period that is less than the second charge period (for example, 1 min.). Although the constant current charge period is divided into the first through third charge periods in the above description, the current embodiment is not limited thereto and the constant current charge period may be divided into two, or four or more charge periods.

In the constant current charge period, initially, the constant current charge unit 710 performs a first constant current charge step for charging the battery 100 at the first charge current for the first charge period. When the first constant current charge step is completed, the constant current charge unit 710 performs a second constant current charge step for charging the battery 100 at the second charge current for the second charge period. When the second constant current charge step is completed, the constant current charge unit 710 performs a third constant current charge step for charging the battery 100 at the third charge current for the third charge period. When the third constant current charge step is completed, a constant voltage charge step is performed in a constant voltage charge period.

The first through third constant current charge steps are performed when the battery 100 is fully discharged. However, in actual cases, the battery 100 may be charged even when the battery 100 has a remaining capacity. The constant current charge step when the battery 100 has a remaining capacity will now be described.

The constant current charge unit 710 starts the first constant current charge step to charge the battery 100 at the first charge current for the first charge period. However, if a charge current of the battery 100 is maintained at a current less than the first charge current (for example, a current less than 6.9 A) for a certain period (for example, 10 sec.), the charge control unit 730 determines that the battery 100 has a first remaining capacity and moves to the second constant current charge step regardless of the first charge current and the first charge period. Here, the first remaining capacity of the battery 100 refers to a case when the capacity of the battery 100 is greater than a battery capacity value set for the first constant current charge step using the first charge current.

Then, the constant current charge unit 710 starts the second constant current charge step to charge the battery 100 at the second charge current for the second charge period. However, if the charge current of the battery 100 is maintained at a current less than the second charge current (for example, a current less than 5.9 A) for a certain period (for example, 10 sec.), the charge control unit 730 determines that the battery 100 has a second remaining capacity and moves to the third constant current charge step regardless of the second charge current and the second charge period. Here, the second remaining capacity of the battery 100 refers to a case when the capacity of the battery 100 is greater than a battery capacity value set for the second constant current charge step using the second charge current. Also, the second remaining capacity of the battery 100 in the second constant current charge step may be greater than the first remaining capacity of the battery 100 in the first constant current charge step.

As described above, since it is determined that the battery 100 has a remaining capacity, if the battery 100 is continuously charged for a certain period at a current less than a charge current set to each step, and the battery 100 is charged at a charge current and a charge period of a next step regardless of the set charge current and the charge period, a charge time of the battery 100 may be reduced.

In the constant current charge step, the charge control unit 730 measures a temperature of the battery 100 and controls a charge operation of the constant current charge unit 710. If the temperature of the battery 100 is greater than a predetermined temperature (for example, 45° C.), the charge control unit 730 stops the charge operation of the constant current charge unit 710. After that, if the temperature of the battery 100 drops to a temperature less than the predetermined temperature, the charge operation of the constant current charge unit 710 is restarted.

In the first constant current charge step, the charge control unit 730 stops the first constant current charge step and stands by if the temperature of the battery 100 is greater than a predetermined temperature, and then performs the first constant current charge step again for a remaining charge period if the temperature of the battery 100 drops to a temperature less than the predetermined temperature. In the second constant current charge step, the charge control unit 730 stops the second constant current charge step and stands by if the temperature of the battery 100 is greater than a predetermined temperature, and then performs the second constant current charge step again for a remaining charge period if the temperature of the battery 100 drops to a temperature less than the predetermined temperature. In the third constant current charge step, the charge control unit 730 stops the third constant current charge step and stands by if the temperature of the battery 100 is greater than a predetermined temperature, and then performs the third constant current charge step again for a remaining charge period if the temperature of the battery 100 drops to a temperature less than the predetermined temperature. As such, a lifetime of the battery 100 may be increased due to the above-described constant current charge stop/restart operation according to the temperature of the battery 100.

When the first through third constant current charge steps are completed, the constant voltage charge unit 720 charges the battery 100 at a certain charge voltage (for example, 20.5 V) for a certain period (for example, 7 min.) in the constant voltage charge period. Even in the constant voltage charge period, the charge control unit 730 monitors a charge current and stops a charge operation of the battery 100 if the charge current is less than a certain value (for example, 1 A).

FIG. 3 is a graph showing a charge curve of the battery 100 illustrated in FIG. 1. Referring to FIG. 3, in a constant current charge period, the battery 100 is charged by applying first through third charge currents and first through third charge periods in steps. As such, a charge time of the battery 100 may be reduced.

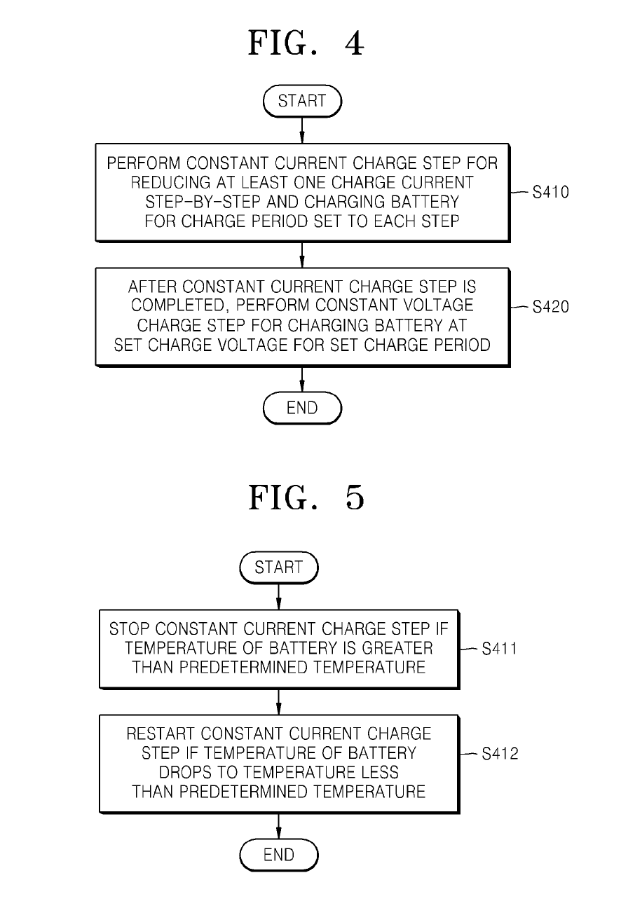

FIG. 4 is a flowchart of a battery charge method according to an embodiment of the present invention. The battery charge method may be performed by the control unit 700 in association with other elements illustrated in FIG. 1. In the following descriptions, descriptions provided above in relation to FIGS. 1 through 3 are not repeated.

Referring to FIG. 4, the control unit 700 performs a constant current charge step for reducing at least one charge current in steps and charging the battery 100 for a charge period set to each step (S410).

After the constant current charge step is completed, the control unit 700 performs a constant voltage charge step for charging the battery 100 at a set charge voltage for a set charge period (S420).

FIG. 5 is a flowchart of a battery charge stop/restart operation in the method illustrated in FIG. 4. In the following descriptions, descriptions provided above in relation to FIGS. 1 through 4 are not repeated.

Referring to FIG. 5, the control unit 700 senses a temperature of the battery 100 and stops a charge operation of the battery 100 if the temperature of the battery 100 is greater than a certain temperature (S411).

After that, if the temperature of the battery 100 is sensed and drops to a temperature less than the predetermined temperature, the control unit 700 restarts the charge operation of the battery 100 (S411).

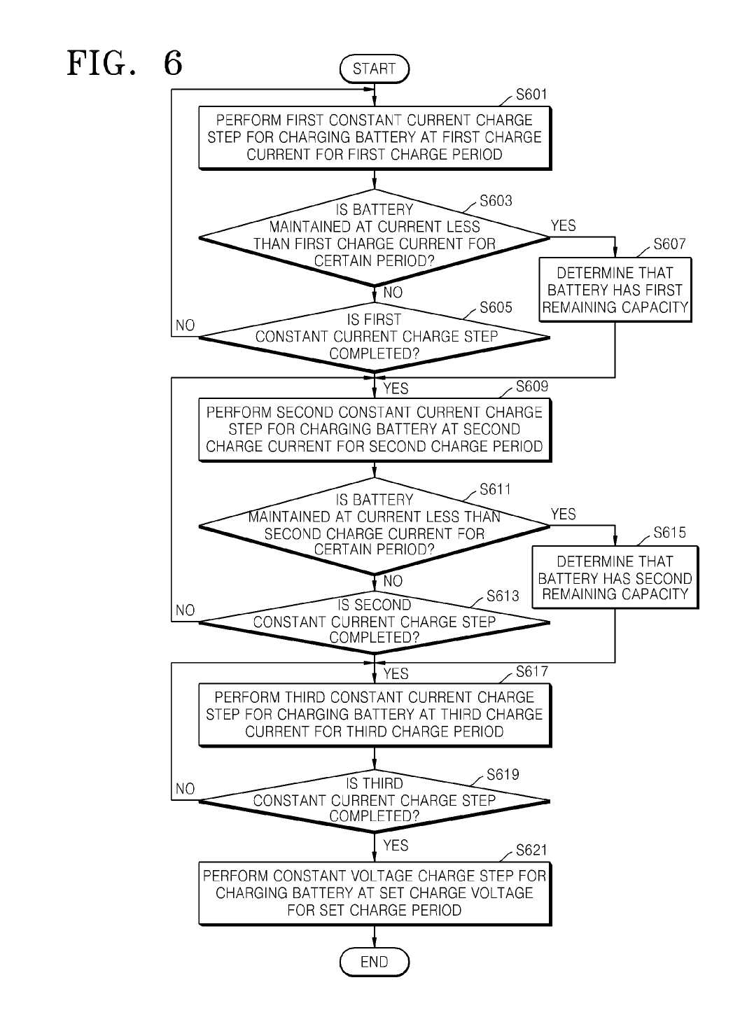

FIG. 6 is a detailed flowchart of the method illustrated in FIG. 4. In the following descriptions, descriptions provided above in relation to FIGS. 1 through 5 are not repeated.

Referring to FIG. 6, in a constant current charge period, the control unit 700 performs a first constant current charge step for charging the battery 100 at a first charge current for a first charge period (S601).

During the first constant current charge step, the control unit 700 determines whether the battery 100 is maintained at a current less than the first charge current for a predetermined period (S603).

If it is determined that the battery 100 is maintained at the first charge current, the control unit 700 determines whether the first constant current charge step is completed (S605) and continues the first constant current charge step if the first constant current charge step is not completed.

However, if the battery 100 is maintained at the current less than the first charge current for the predetermined period, the control unit 700 determines that the battery 100 has a first remaining capacity, and moves to a second constant current charge step regardless of the first charge period (S607).

If the first constant current charge step is completed, or if the battery 100 is maintained at the current less than the first charge current for the predetermined period, in the constant current charge period, the control unit 700 performs the second constant current charge step for charging the battery 100 at a second charge current for a second charge period (S609).

During the second constant current charge step, the control unit 700 determines whether the battery 100 is maintained at a current less than the second charge current for a predetermined period (S611).

If it is determined that the battery 100 is maintained at the second charge current, the control unit 700 determines whether the second constant current charge step is completed (S613) and continues the second constant current charge step if the second constant current charge step is not completed.

However, if the battery 100 is maintained at the current less than the second charge current for the predetermined period, the control unit 700 determines that the battery 100 has a second remaining capacity, and moves to a third constant current charge step regardless of the second charge period (S615).

If the second constant current charge step is completed, or if the battery 100 is maintained at the current less than the second charge current for the predetermined period, in the constant current charge period, the control unit 700 performs the third constant current charge step for charging the battery 100 at a third charge current for a third charge period (S617).

Then, the control unit 700 determines whether the third constant current charge step is completed (S619) and continues the third constant current charge step if the third constant current charge step is not completed.

If the third constant current charge step is completed, the control unit 700 performs a constant voltage charge step for charging the battery 100 at a set charge voltage for a set charge period (S621).

Thereafter, even in the constant voltage charge period, the control unit 700 monitors a charge current and stops a charge operation of the battery 100 if the charge current is less than a predetermined value (for example, 1 A).

As described above, according to one or more of the above embodiments of the present invention, a charge time of a battery may be reduced by reducing a charge current of a constant current charge period of the battery step-by-step.

It should be understood that the embodiments described therein should be considered in a descriptive sense only and not for purposes of limitation. Descriptions of features or aspects within each embodiment should typically be considered as available for other similar features or aspects in other embodiments.

What is claimed is:

1. A method of charging a battery, the method comprising:
supplying a first current for charging the battery for a first charge period;
supplying a second current for charging the battery for a second charge period, wherein the second current is less than the first current; and
supplying a voltage for charging the battery for a set charge period.

2. The method of claim 1 further comprising:
determining whether the battery has a remaining capacity if the battery is maintained at a current less than the first or the second current; and
charging the battery at the first or second current.

3. The method of claim 1 further comprising:
stopping a charge operation of the battery if a temperature of the battery is greater than a predetermined temperature; and
restarting the charge operation of the battery if the temperature of the battery drops to a temperature less than the predetermined temperature.

4. The method of claim 1 further comprising supplying a third current for charging the battery for a third charge period, wherein the third current is less than the second current.

5. The method of claim 1, wherein, if the battery is maintained at a current less than the first current for a predetermined period, it is determined that the battery has a first remaining capacity, and the battery is charged up to the second current regardless of the first charge period.

6. The method of claim 4, wherein, if the battery is maintained at a current less than the second current for a predetermined period, it is determined that the battery has a second remaining capacity, and the battery is charged up to the third t current regardless of the second charge period.

7. A system for charging a battery, the system comprising:
the battery comprising at least one battery cell;
a constant current charge unit for supplying a first current for charging the battery for a first charge period, and supplying a second current for charging the battery for a second charge period, wherein the second current is less than the first current;
a constant voltage charge unit for supplying a set voltage for charging the battery for a set charge period; and
a charge control unit for monitoring a state of the battery and controlling operations of the constant current charge unit and the constant voltage charge unit.

8. The system of claim 7, wherein the charge control unit determines whether the battery has a remaining capacity if the battery is maintained at a current less than the first or second current for a predetermined period, and charges the battery at the first or second current regardless of the set charge period.

9. The system of claim 7, further comprising a temperature measuring unit for measuring a temperature of the battery.

10. The system of claim 9, wherein the charge control unit stops operation of the constant current charge unit if the temperature of the battery is greater than a predetermined temperature, and restarts the operation of the constant current charge unit if the temperature of the battery drops to a temperature less than the predetermined temperature.

11. The system of claim 7, wherein the constant current charge unit supplies:
a first current for a first charge period;
a second current less than the first current for a second charge period; and
a third current less than the second current for a third charge period.
